(19) United States
(12) Patent Application Publication
(10) Pub. No.: US 2024/0421575 A1
(43) Pub. Date: Dec. 19, 2024

(54) Cable Support

(71) Applicant: Clinton Jarrett Smith, Belmont, NC (US)

(72) Inventor: Clinton Jarrett Smith, Belmont, NC (US)

(21) Appl. No.: 18/336,979

(22) Filed: Jun. 17, 2023

(51) Int. Cl. H02G 3/32

(52) U.S. Cl. CPC H02G 3/32

(57) ABSTRACT

The present disclosure includes systems, devices, and methods of securing a cable with respect to various building components. For example, an apparatus to secure a cable may include a first component configured to be coupled to each of a building component and a second component. The second component may be configured to define at least a portion of a space for a cable and apply a force to the cable to secure the cable. Other aspects and features are also claimed and described.

### TECHNICAL FIELD

The present disclosure relates generally to support for cables run throughout a building, and more specifically, but not by way of limitation, to a cable staple for cables run throughout a building.

### BACKGROUND

Cables are run throughout buildings to transmit signals within the building, including but not limited to electricity, data, and other forms of signals. Cables run throughout a building include but are not limited to nonmetallic sheathed cables, armored cables, instrumentation cables, low voltage cables, fiber optic cables, and communication cables. Cables run throughout a building need to be secured along their desired path. Securing the cables is often required by code and prevents the cables from being pierced or pinched by nails, sheetrock, and other material used during construction or renovation of a building.

The current manner of securing cables throughout a building is problematic. Under the current method using current staples, cables are placed against a building material upon which the cable needs to be secured, such as a framing stud or other building component, and a staple is fastened over the cable to the building component, securing the cable against the building component. The traditional manner of securing cables creates several problems. The current staples often accidentally pierce the cable when being secured to the building component. Additionally, it is difficult to apply a proper amount of force to secure the cable without pinching the cable when the force required to secure the staple to the building component is larger than the force needed to secure the cable from moving. A tool such as a hammer, screwdriver, drill, staple gun, or the like is often required achieve the force needed to secure the staple to the building component, and balancing the coupling force between the building and the staple with the force required to secure the cable is difficult. The traditional manner of securing cables is also time consuming. The installer takes additional time and care to ensure they do not pierce or pinch the cable.

The present invention discloses a new cable staple in which a first portion of a cable staple may be attached to a building component where attaching the first portion to the building component is independent from securing the cable. By securing a first portion of the cable staple to a building component independent from securing the cable, the amount of time and care need to secure a cable within a building is reduced. With the new cable staple, the cable may be placed against the first portion of the cable stable and the cable may be secured by securing a second portion of the cable staple to the first portion of the cable staple after the first portion of the cable staple has been attached to a building component. The present disclosure enables the second portion of the cable staple to be secured with a minimal amount of force. By enabling an installer to secure the cable with minimal force, there is no risk the installer might accidentally pierce or pinch the cable. Thus, the installer can secure cables throughout a building much faster and with less error.

### SUMMARY

Aspects of the present disclosure are related to systems, methods, and apparatuses of securing cables to building components within residential and commercial buildings. For example, the present disclosure may enable an installer of a cable within a building to quickly secure cables throughout a building while eliminating risks of piercing or pinching the cable when securing it. Additionally, the present disclosure significantly reduces the skill and time required of an individual installing cables within a building.

The present disclosure may include a first component configured to couple to each of a building component and a second component. The second component may define at least a portion of a space for a cable and may apply a force to the cable to secure the cable. A coupling force between the first component and the second component may create the force to secure the cable.

The first component may be coupled to the building component before it is coupled to the second component. Coupling the first component to the building component may be independent of securing a cable, which may allow a cable installer to quickly secure the first component of an apparatus configured to secure a cable. The cable installer may move quickly when coupling the first component because the cable installer may not be concerned with pinching or piercing the cable. In some implementations, an installer may carry a drill with a magnetic screw bit and multiple first components which may each include a screw configured to secure each of the first components to the building components. The installer may quickly attached the magnetic drill bit to the screw to secure each of the first components as need to various building components, such as a wall stud. The installer will be able to secure the first components much faster than was previously possible since the installer will not be concerned with piercing or pinching the cable.

The force needed to couple the first component to the building component is high since the building component is typically pierced in some way, such as by a screw or a nail, to couple the first component to the building component. Under the present disclosure, the force needed to secure the cable with the second component may be lower than the force needed to couple the first component to the building component such that an installer can establish the force to secure the cable by moving the second component relative to the first component with their hand. Thus, the installer will never accidentally pierce or pinch the cable when securing the cable.

An installer may secure multiple first components to building components along a planned cable route quickly before securing a cable. Once the first components are coupled to building components along a desired path, an installer may run a cable along the route and secure the cable at the various first components by coupling a second component to a first component to secure the cable. The installer may quickly run cable along the desired path given the simplicity and low force needed to secure the cable by coupling the first component to the second component.

In some implementations, the cable may be secured between the first component and the second component. Securing the cable between the first component and the second component may make it easier for an installer to properly secure a cable. For example, after the first component is secured to the building component, the cable may be placed at a center of the first component and the second component may be coupled to the first component by pushing the second component into the first component with the cable between the first component and the second component. The amount of force the installer uses to push the second component into the first component may correspond with the amount of force that secures the cable in place. It is easier for an installer to assert the proper cable securing force when they are not simultaneously coupling a cable staple component to a building component. Thus, the installer may be able to use the minimum amount of force necessary to secure the cable and prevent any damage to the cable when securing it.

In some implementations, the second component may be configured to lock positions relative to the first component when the second component is in each of a first position and a second position. The first position may correspond with a space defined by the second component being larger than a space defined by the second component when the second component is in the second position. The first component may allow movement of the second component from the first position to the second position, but the first component may prevent movement of the second component from the second position to the first position. Such an arrangement may enable a force exerted by an installer in coupling the first component to the second component to secure the cable to remain once the installer removes the force. For example, if a first force from an installer is used to position the second component in the second position and that first force corresponds with a securing force against the cable, the securing force will remain after the installer couples the first component and the second component in the second position if the second component does not move off of the cable when the first force is removed. Such an arrangement may also enable the first component and the second component to secure multiple sized cables. For example, the first position may correspond with positions of the first component and second component needed to secure a first cable. The second position may correspond with positions of the first component and the second component needed to secure a second cable, the second cable smaller than the first cable.

In a particular aspect of the present disclosure, an apparatus may include a first component configured to be coupled to each of a building component and a second component, the second component configured to define at least a portion of a space for a cable and apply a force to the cable to secure the cable.

In some implementations, the second component is configured to apply the force to the cable to secure the cable when coupled to the first component

In some implementations, the first component may be configured to apply a second force to the cable to secure the cable.

In some implementations, the first component may be configured to define at least a portion of the space for the cable

In some implementations, the space may be interposed between the first component and the second component.

In some implementations, the first component may include a first side and a second side different from the first side, the first side configured to be coupled to the building component, the second side configured to be coupled to the second component. In some such implementations, the space may be interposed between the second side and the second component. In some such implementations, the second side may be interposed between the first side and the second component.

In some implementations, the first component and the second component may be configured to secure the cable between the first component and the second component.

In some implementations, the first component may be separate from the second component.

Additionally or alternatively, the apparatus may include the second component.

In some implementations, the second component may include one or more protrusions configured to couple the second component to the first component, and the first component may include on or more cuts configured to match the one or more protrusions.

In some implementations, the second component may be configured to contact the cable when coupled to the first component.

In some implementations, the first component may be configured to contact the cable.

In some implementations, the force may be configured to prevent cable movement with respect to the building component.

In some implementations, the second component may be configured to couple to the first component at a first position, the second component may be configured to couple to the first component at a second position, and the first component may be configured to allow movement of the second component from the first position to the second position and prevent to movement of the second component from the second position to the first position, the space when the second component is at the second position smaller than the space when the second component is at the first position.

In some implementations, the second component may be configured to be coupled to a third component, the third component configured to define at least a portion of a space for a second cable and apply a second force to the second cable to secure the second cable when coupled to the second component.

In another particular aspect of the present disclosure, a method for securing a cable to a building component may include coupling a first component to a building component, positioning the cable at a side of the first component, and coupling the second component to the first component to secure the cable, the second component configured to define at least a portion of a space for the cable and apply a force to secure the cable.

Additionally or alternatively, the method for securing a cable to a building component may include moving the second component from a first position to a second position, the second component coupled to the first component at each of the first position and the second position, the first component configured to allow movement of the second component from the first position to the second position and prevent movement of the second component from the second position to the first position, the space when the second component is at the second position smaller than the space when the second component is at the first position.

Additionally or alternatively, the method for securing a cable to a building component may include positioning a first side of the first component against the building component, wherein the cable is positioned against a second side of the first component, the first side opposite the second side, the cable interposed between the second side and the second component, and the second side interposed between the first side and the cable.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. Two items that are coupled may move relative to each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, and 10 percent.

As used herein, directional terminology is used for the purpose of describing the fixtures only and is not intended to be limiting of the implementations. Directional terminology is used with respect to the figure being described. For example, if left is referred to in describing a figure, left is used to distinguish a location of the figure as demonstrated on a page. Left is not intended to be limiting and the same portion of a figure referred to as left could be referred to with different directional language if the figure showed a different orientation.

The phrase “and/or” means and or or. To illustrate, A, B, and/or C includes: A alone, B alone, C alone, a combination of A and B, a combination of A and C, a combination of B and C. or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”. Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

Some details associated with the implementations are described above, and others are described below. Other implementations, advantages, and features of the present disclosure will become apparent after review of the entire application, including the following sections: Brief Description of the Drawings, Detailed Description, and the Claims. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims.

The novel features which are disclosed herein, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

FIG. 1A is an overhead perspective view of an example of a first component of an apparatus configured to define at least a portion of a space for a cable.

FIG. 1B is a top view of FIG. 1A.

FIG. 1C is a side view of FIG. 1A.

FIG. 1D is a cross-sectional view of FIG. 1C.

FIG. 1E is a view of a portion of FIG. 1D.

FIG. 2A is an overhead perspective view of an example of a second component of an apparatus configured to define at least a portion of a space for a cable.

FIG. 2B is a top view of FIG. 2A.

FIG. 2C is a side view of FIG. 2A.

FIG. 2D is a cross-sectional view of FIG. 2C.

FIG. 2E is a view of a portion of FIG. 2D.

FIG. 3A is an overhead perspective view of an example of an apparatus configured to define at least a portion of a space for a cable.

FIG. 3B is a side view of FIG. 3A with a first component of the apparatus positioned above a second component.

FIG. 3C is a is a side view of FIG. 3A with a first component of the apparatus coupled to a second component.

FIG. 3D is a cross-sectional view of FIG. 3C.

FIG. 3E is a view of a portion of FIG. 3D.

### DETAILED DESCRIPTION

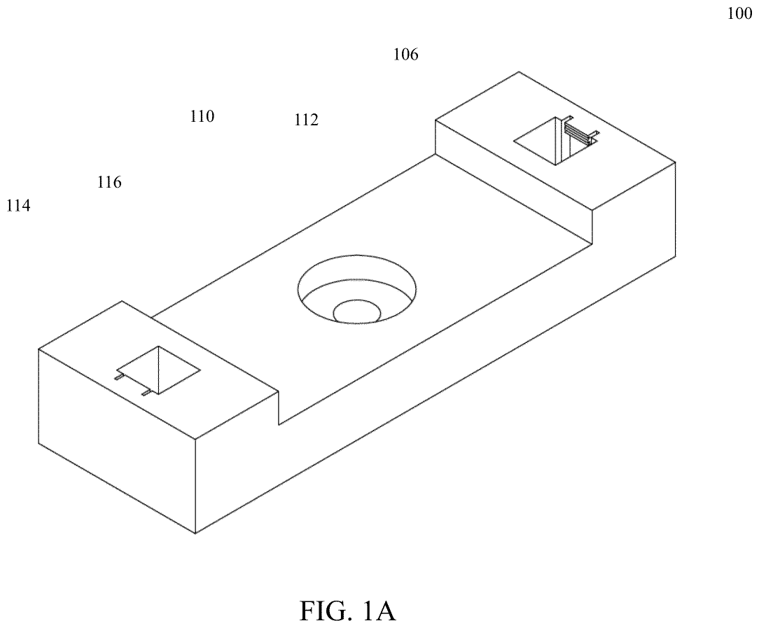

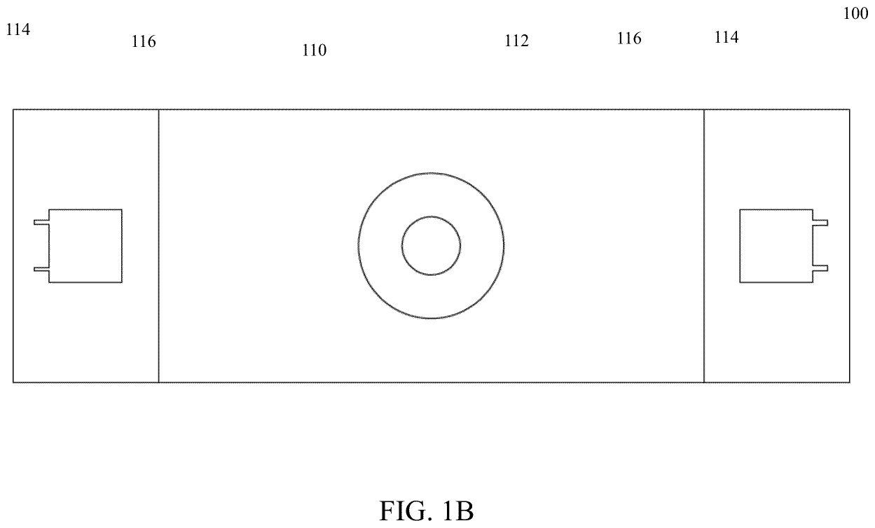

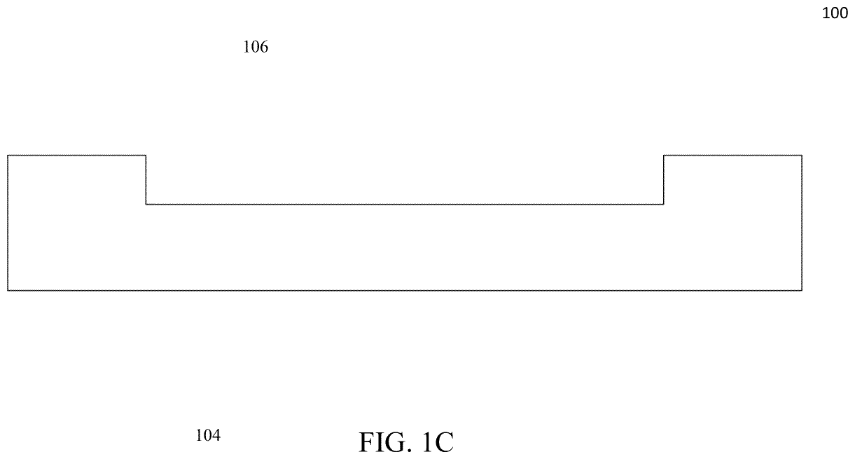

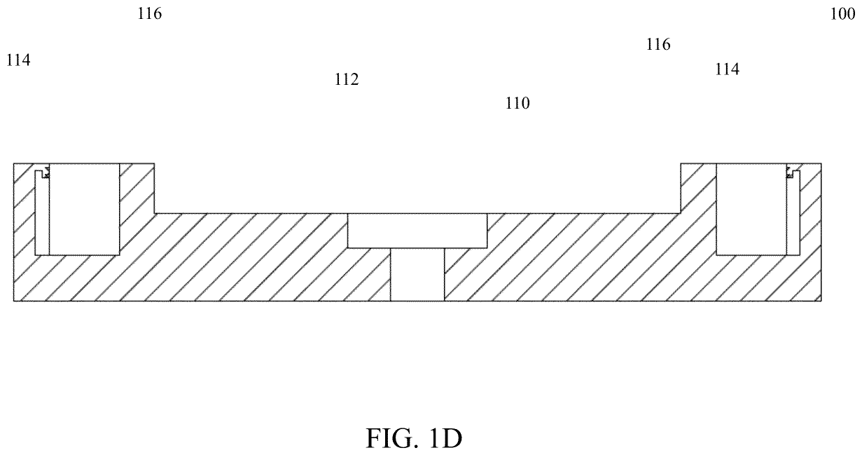

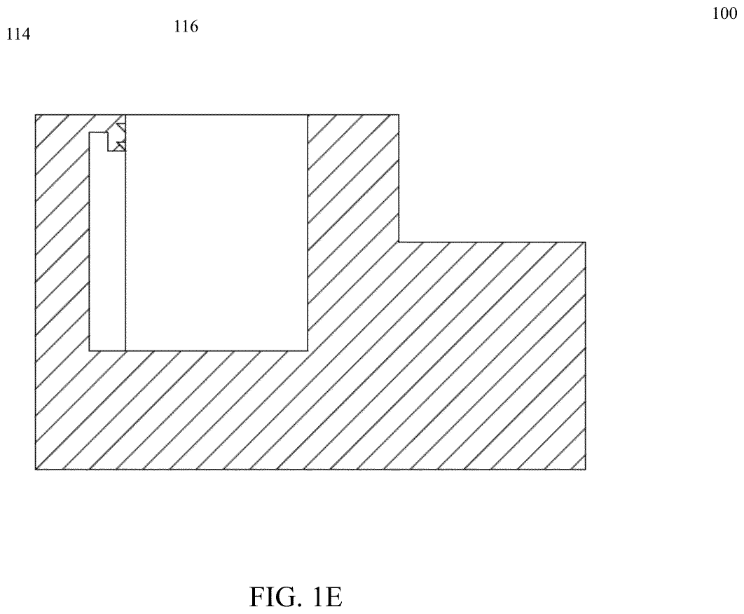

Referring to FIG. 1A, an overhead perspective view of an example of a first component 100 of an apparatus configured to define at least a portion of a space for a cable is shown. In some implementations, the first component 100 may include a second side 106, a first hole 110, a second hole 112, a tab 114, and a second component cutout 116.

The first component 100 may be configured to be coupled to a component of a building. In some implementations, a first side 104 of the first component 100 may be configured to be coupled to the building component. The building component may define a portion of a building. The building component could be any portion of a building upon which a cable may be secured to. The component of the building may be a framing component. As non-limiting examples, the building component may be, but is not limited to, a stud, a plate, a header, or a joist. The component of the building may be wood, metal, or any other material used in a building. The building may residential or commercial. The space defined for a cable may be for any type of cable, including but not limited to cables that transmit, as non-limiting examples, electricity, data, and other forms of signals. The cables could include but are not limited to nonmetallic sheathed cables, armored cables, instrumentation cables, low voltage cables, fiber optic cables, and communication cables. The cable could be a wire.

The first component 100 may include a fastener portion. The fastener portion may be configured to receive a fastener and the fastener may be configured to couple the first component 100 to the building component. The fastener may be a screw, a nail, or other component configured for coupling two items together.

The fastener portion of the first component 100 may include a first hole 110 partially through a second side 106 of the first component 100 and a second hole 112 through each of the second side 106 and a first side 104 of the first component 100. The second hole 112 may be smaller than the first hole 110. The second hole 112 may be sized such that a body of a fastener can fit through the second hole 112, but a head of the fastener may not. By sizing the first hole 110 and the second hole 112 in such a manner, a fastener body may be inserted through the first hole 110 and the second hole 112 and coupled to a building component. Since the fastener head cannot pass through the second hole 112, the coupling force between the building component and the fastener may be exerted against the first component 100 such that the first component 100 does not move certain directions with respect to the building component.

The depth of the first hole 110 may be sized to equal or be slightly larger than the depth of a fastener head. By sizing the depth of the first hole 110 to equal or be slightly larger than the depth of a fastener head, the fastener head may be positioned within the first component 100 such that is does not extrude from the second side 106. By sizing the first component 100 such that the fastener head does not extrude from the second side 106, a flat surface is created upon which a cable can rest when the first component 100 is coupled to a building component.

In some implementations, the second hole 112 may be sized slightly smaller than the maximum diameter of a body of a fastener. A material of the second hole 112 may be such that the material compresses or deflects when a fastener is pushed through the second hole 112. In some such implementations, a fastener could be positioned within the second hole 112 by forcing the fastener into the second hole such that the material of the first component 100 compresses or deflects. By sizing the second hole 112 slightly smaller than the diameter of a fastener body, the fastener may be positioned within the second hole 112 such that the compression force, friction force, both forces, or other forces between the fastener and the compressed or deflected material prevents the fastener from sliding out of the second hole 112 when no other forces are applied. In some such implementations, a fastener may be paired and remain paired with the first component 100 prior to coupling the fastener to a building component.

In some alternative implementations, the second hole 112 may include a slight projection of thin material into the diameter of the second hole 112. The clearance where the projection is positioned may be slightly smaller than the diameter of a fastener body. The projection may be configured to deflect such that the fastener may pass through. The compression force, friction force, both forces, or other forces between the deflected material and the fastener may prevent the fastener from sliding out of the second hole 112 when no other forces are applied. In such alternative implementations, a fastener may be paired and remain paired with a first component 100 prior to coupling the fastener to a building component.

In alternative implementations, the first component 100 could be coupled to a building component in other ways. As a nonlimiting example, while FIG. 1A shows a fastener portion positioned relatively centered with respect to the body of the first component 100, the fastener portion could be positioned on a side of the first component 100. Alternative implementations include but are not limited to the use of adhesives or other arrangements for coupling the first component 100 to a building component.

The second side 106 of the first component 100 may define at least a portion of a space for a cable. As a non-limiting example, after the first component 100 is coupled to a building component, a cable may be positioned against the second side 106 of the first component 100. The second side 106 may prevent movement of the cable in a certain direction.

The first component 100 may include a lip on opposite ends of the second side 106. The lips may prevent the cable positioned against the second side 106 of the first component 100 from moving in certain directions. In some alternative implementations, the second side 106 of the first component 100 may not include lips or may only include one lip.

The first component 100 may include a second component cutout 116 on the second side 106. The second component cutout 116 may be sized such that an extension of a second component may fit within the second component cutout 116. The depth of the second component cutout 116 may be sized such that the entirety of an extension of a second component may fit within the second component cutout 116.

The second component cutout 116 may include a tab 114. The tab 114 may be configured to allow an extension of a second component to enter the second component cutout 116 and configured to prevent the extension of the second component from being removed from the second component cutout 116 after it enters the second component cutout 116.

Referring to FIG. 1B, a top view of an example of a first component 100 of an apparatus configured to define at least a portion of a space for a cable is shown. Slots may be positioned on opposite sides of each tab 114. The slots may enable the tab 114 to deflect down when a force is exerted down on the tab 114. The tab 114 may be configured to return to its resting, original position when no force is applied to the tab 114. The tab 114 may be configured to only deflect one direction, such as downward, such that the tab 114 only allows movement in the direction it deflects.

Referring to FIG. 1C, a side view of an example of a first component 100 of an apparatus configured to define at least a portion of a space for a cable is shown. The first component 100 may include a first side 104.

The first side 104 may be opposite the second side 106. The first side 104 may be configured to rest against a building component when the first component 100 is coupled to the building component.

Referring to FIG. 1D, a cross-sectional side view of an example of a first component 100 of an apparatus configured to define at least a portion of a space for a cable is shown.

Referring to FIG. 1E, a cross-sectional side view of a portion of an example of a first component 100 of an apparatus configured to define at least a portion of a space for a cable is shown.

The tab 114 may include one or more shaped cuts on a face of the tab 114 facing the second component cutout 116. Each cut may include a side substantially orthogonal to the direction an extension of a second component is configured to enter the second component cutout 116. Each cut may also include a side angled from an end of the orthogonal side towards the middle of the second component cutout 116. By shaping cuts on the face of the tab 114 in such a manner, protrusions of an extension of a second component configured to match the cuts on the face of the tab 114 may slide downwards against the face of the tab 114 but may not slide upwards against the face of the tab 114.

The tab 114 may be shaped in a manner such that a space with no material is behind at least a portion of the face of the tab 114 facing the second component cutout 116. The space with no material may enable the tab to deflect away from the second component cutout 116 as needed to allow an extension of a second component to move into the second component cutout 116. The tab 114 may deflect when protrusions of an extension of a second component are sliding down against the tab 114 and not in a position corresponding with the protrusions of the second component mating with the cuts of the tab 114. The tab 114 may be configured to return to its resting, original position when no force is applied to the tab 114 such that when protrusions of an extension of a second component are mating with cuts of the tab 114, the tab 114 is in its original position and prevents the extension of the second component from moving upwards.

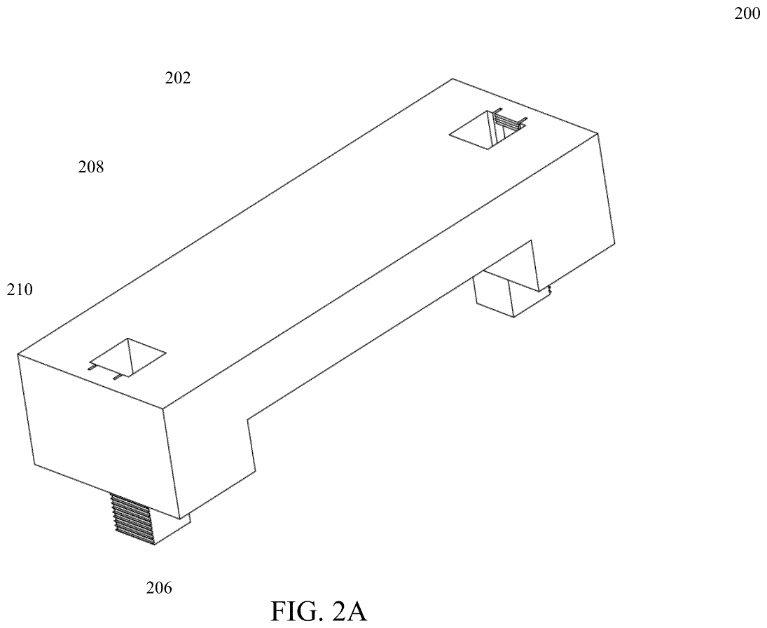

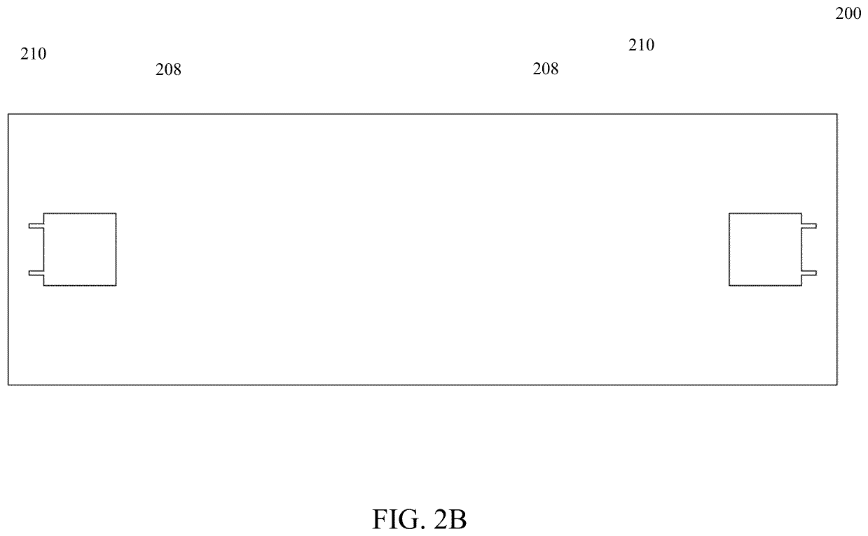

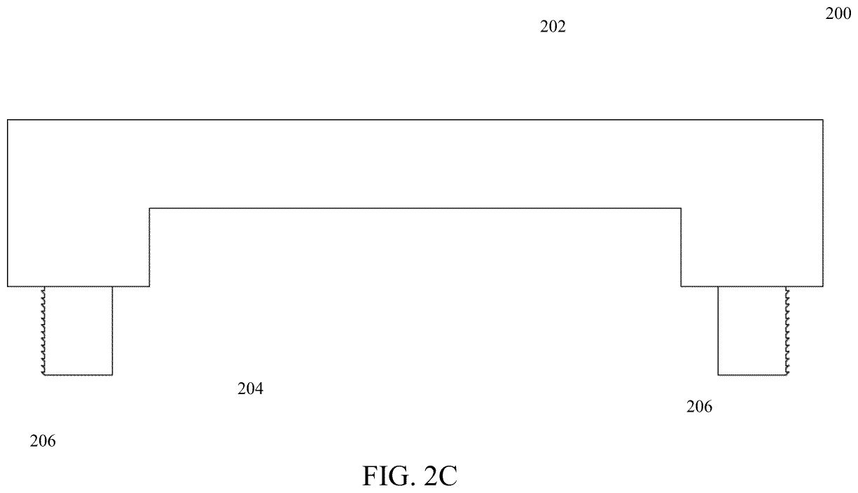

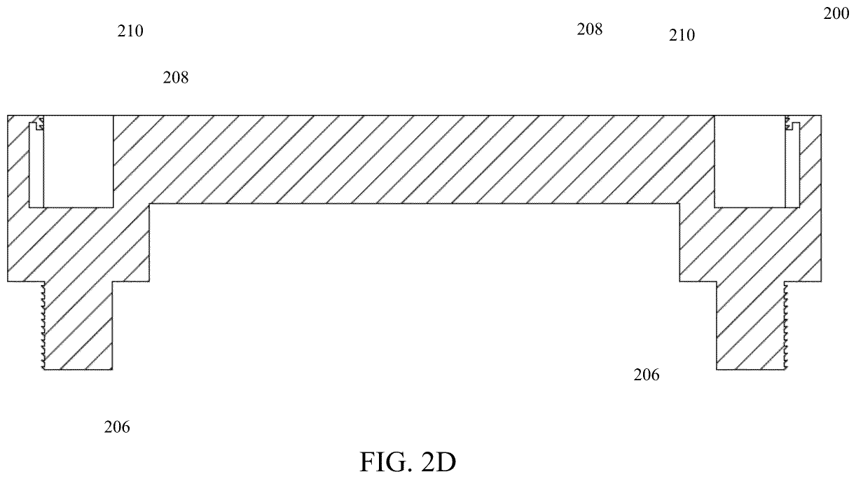

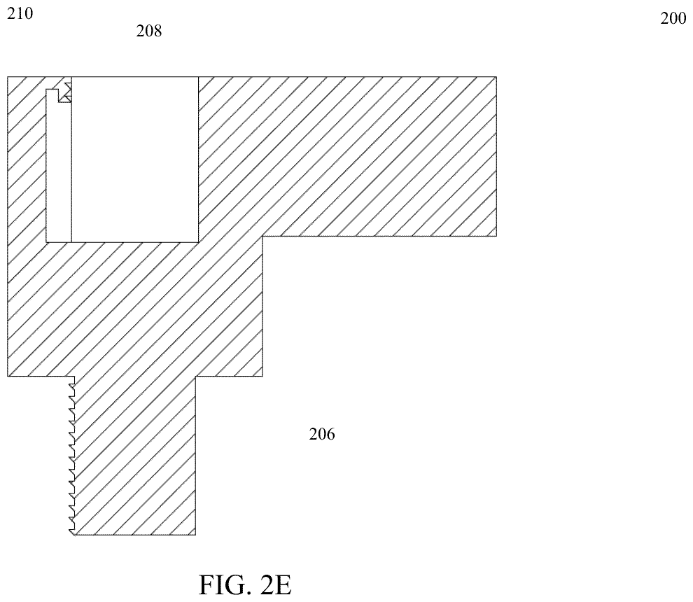

Referring to FIG. 2A, an overhead perspective view of an example of a second component 200 of an apparatus configured to define at least a portion of a space for a cable is shown. In some implementations, the second component 200 may include a fourth side 202, an extension 206, a stacking component cutout 208 and a stacking component tab 210.

The second component 200 may be configured to be secured to a first component to define at least a portion of a space for a cable. The extension 206 may configured to couple the second component 200 to a first component. The extension 206 may be sized such that it fits within a second component cutout of a first component. The length of the extension 206 may be such that the entirety of the extension 206 may fit within the second component cutout.

The second component 200 may include a stacking component cutout 208 on the fourth side 202. The stacking component cutout 208 may be sized such that an extension of a stacking component may fit within the stacking component cutout 208. The extension of a stacking component may be configured to couple a stacking component to the second component 200, defining a space between the stacking component and the fourth side 202 of the second component 200 for a cable. The stacking component and the second component 200 may be configured to secure the cable between the stacking component and the fourth side 202 of the second component 200.

The depth of the stacking component cutout 208 may be sized such that the entirety of an extension of a stacking component may fit within the stacking component cutout 208.

The stacking component cutout 208 may include a stacking component tab 210. The stacking component tab 210 may be configured to allow an extension of a stacking component to enter the stacking component cutout 208 and to prevent the extension of the stacking component from being removed from the stacking component cutout 208 after it enters the stacking component cutout 208.

The size and features of the stacking component cutout 208 and the stacking component tab 210 may mirror those of the first component such that a component mirroring the second component 200 may be used as the stacking component.

Referring to FIG. 2B, a top view of an example of a second component 200 of an apparatus configured to define at least a portion of a space for a cable is shown. Slots may be positioned on opposite sides of each stacking component tab 210. The slots may enable the stacking component tab 210 to deflect down when a force is exerted down on the stacking component tab 210. The stacking component tab 210 may be configured to return to its resting, original position when no force is applied to the stacking component tab 210. The stacking component tab 210 may be configured to only deflect one direction, such as downward, such that the stacking component tab 210 only allows movement in the direction it deflects.

Referring to FIG. 2C, a side view of an example of a second component 200 of an apparatus configured to define at least a portion of a space for a cable is shown. The second component 200 may include a third side 204.

The third side 204 of the second component 200 may define at least a portion of a space for a cable. As a non-limiting example, after a cable is positioned against a second side of a first component, the second component 200 may be coupled to the first component. The cable may be positioned between the first component and the second component 200. A friction force, a compression force, both forces, or other forces may be exerted against the cable from the first component, the second component 200, or both components such that the cable is secured. A coupling force between the first component and the second component 200 may create the force or forces that secures the cable.

The second component 100 may include a lip on opposite ends of the third side 204. The lips may prevent a cable positioned against the third side 204 of the second component 200 from moving in certain directions. In some alternative implementations, the third side 204 of the second component 100 may not include lips or may only include one lip.

Referring to FIG. 2D, a cross-sectional side view of an example of a second component 200 of an apparatus configured to define at least a portion of a space for a cable is shown.

Referring to FIG. 2E, a cross-sectional side view of a portion of an example of a second component 200 of an apparatus configured to define at least a portion of a space for a cable is shown.

The extension 206 may include one or more protrusions configured to mate with one or more shaped cuts on a face of a tab of the first component. The protrusions may be angled such that the protrusions of the extension 206 slide downward into the second component cutout of a first component with minimal resistance from cuts on the face of the tab of the first component. The shapes of the protrusions may prevent the extension 206 of the second component 200 from sliding upwards and out of the second component cutout of the first component based on the manner in which the protrusions fit within the cuts on the tab of the first component.

The width of the extension 206 from left to right of FIG. 2E may be sized such that the protrusions of the extension 206 contact the tab of the first component when the extension 206 is positioned within the second component cutout

In some implementations, the extension 206 may be configured not to deflect as it is pushed into a second component cutout of a first component. If the extension 206 does not deflect, all forces may be exerted against a tab of the first component such that the tab deflects to allow the protrusions of the extension 206 to move downwards and into the cuts of the tab of the first component. In alternative implementations, both the tab of the first component and the extension 206 may deflect as the extension 206 is pushed into the second component cutout of the first component such that each of the tab of the first component and the protrusions of the extension 206 of the second component deflect to allow the protrusions of the extension 206 to move downward and into the cuts of the tab of the first component.

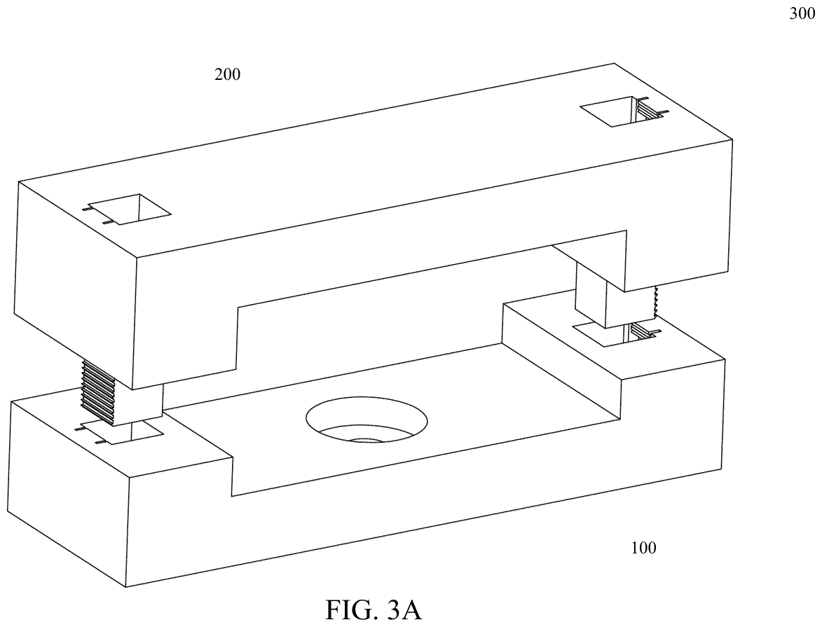

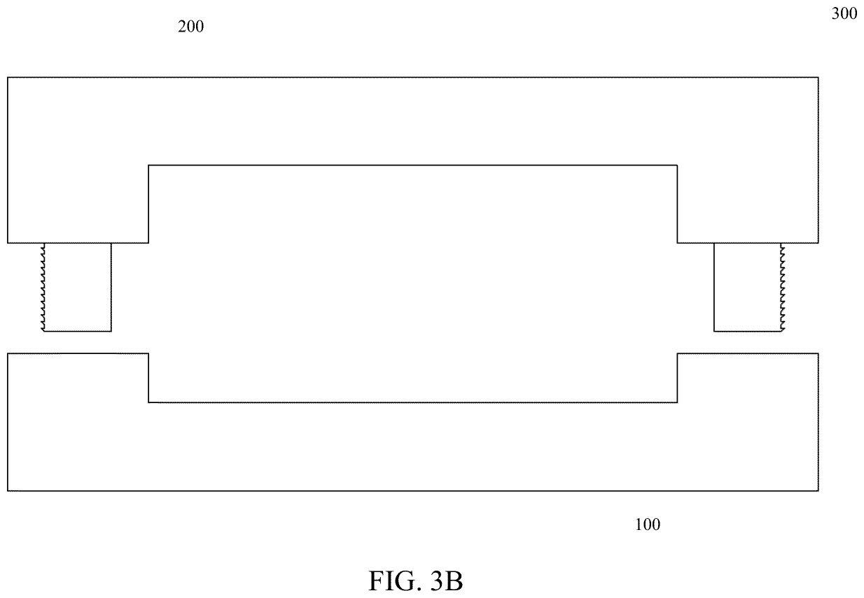

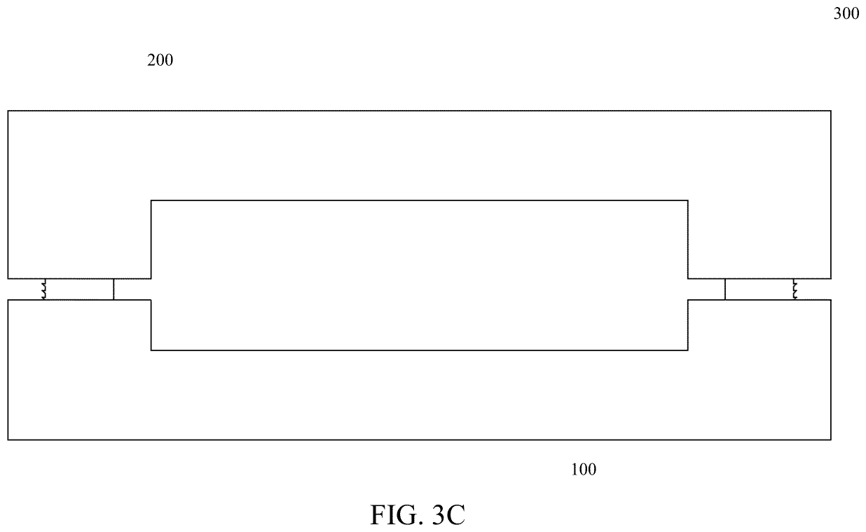

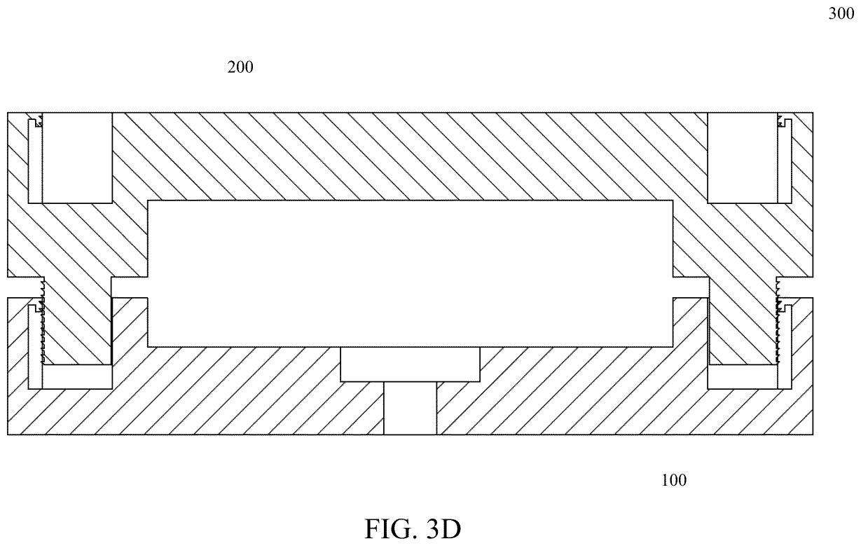

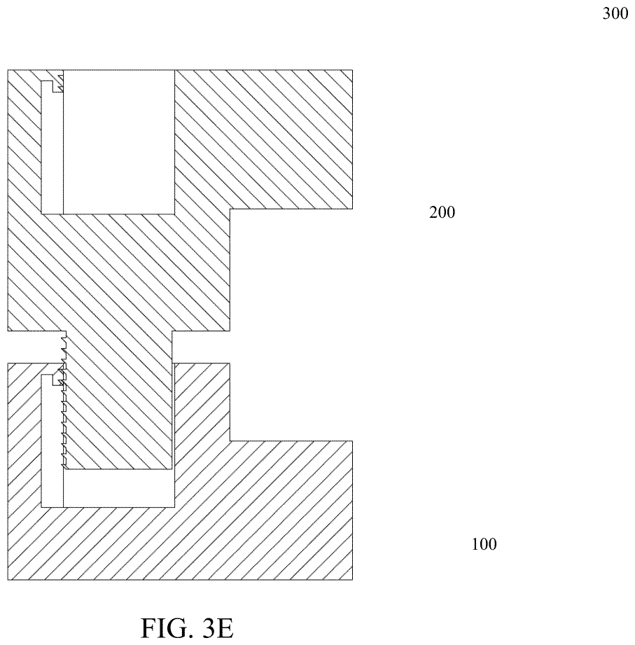

Referring to FIG. 3A, an overhead perspective view of an example of an apparatus 300 configured to define at least a portion of a space for a cable is shown. The apparatus 300 may include a first component 100 and a second component 200.

The first component 100 may be coupled to a building component. After the first component 100 is coupled to a building component, a cable may be positioned against a second side of the first component 100. With the cable positioned against the first component 100, the second component 200 may be coupled to the first component 100 such that the cable is secured between the first component 100 and the second component 200. The first component 100 and the second component 200 may each define at least a portion of a space for the cable. The cable may be secured within the space defined by each of the first component 100 and the second component 200.

In some implementations, the first component 100 may be coupled to the building component with a screw, nail, or other fastener. In some such implementations, a tool such as a screwdriver, hammer, or staple gun, or the like, may be used to secure the first component 100 to the building component. In some implementations, an installer may carry a drill with a magnetic screw bit and multiple first components 100 which may each include a screw within a fastener portion where the screws are configured to secure each of the first components 100 to a building component. The installer may quickly attached the magnetic drill bit to the screw to secure each of the first components 100 to building components along a desired cable path. In alternative implementations, the first component 100 may be secured to a building component by other methods, such as but not limited to nails or adhesives.

The second component 200 may be coupled to the first component 100 by pushing the second component 200 into the first component 100 by hand. A cable may be positioned between the first component 100 and the second component 200 when the second component 200 is coupled to the first component 100. An extension of the second component 200 may fit within a second component cutout of the first component 100 and the size of the space for the cable defined by the first component 100 and the second component 200 may shrink as the second component 200 moves towards the first component 100 and the extension of the second component 200 is pushed into the second component cutout of the first component 100. The second component 200 may be prevented from moving away from the first component 100 once the extension of the second component 200 is inserted due to features of the extension of the second component 200 and a tab of the second component cutout of the first component 100. By preventing the second component 200 from moving away from the first component 100 after the two are pressed together, a securing force may be created between the first component 100 and the second component 200 to secure a cable. The securing force used to secure a cable may be but is not limited to a compression force, friction force, or both.

In alternative implementations, an extension may be a portion of the first component 100 and the second component 200 may include a cutout to receive an extension of the first component 100.

The first component 100 and the second component 200 may be sized such that multiple sized cables can be secured within the space defined by each of the first component 100 and the second component 200. In implementations in which there are multiple protrusions on a face of an extension of a second component 200, the protrusions of the extension of the second component 200 may slide down against a shaped cut on a face of the tab of the first component 100 as the extension is pushed into the second component cutout of the first component 100. The space configured to receive the cable may reduce as the extensions slides down. The first component and second component may secure a cable size corresponding to any of the locking positions of the multiple protrusions of the extension of the second component 200. The ability to reduce the space for a cable may enable the first component 100 and the second component 200 to secure multiple sized cables.

In some implementations, the first component 100 and the second component 200 may be sized such that the cable is secured between each of the first component 100 and the second component 200 before the entirety of an extension of the second component 200 is positioned within a second component cutout of the first component 100.

As a non-limiting example, the first component 100 and the second component 200 could secure a first sized cable by securing the cable against a second side of the first component 100 and a third side of the second component 200 when an extension of the second component 200 is positioned at a first position within the second component cutout of the first component 100. The extension of the second component may be locked in the first position based on a first protrusion on the extension of the second component 200 mating with a cut on a tab face of the first component 100.

To secure a second sized cable, which is smaller than the first sized cable, the extension of the second component 200 could be pressed further into the second component cutout of the first component 100 such that the smaller, second sized cable is secured against the second side of the first component 100 and the third side of the second component 200. The extension of the second component may be locked in a second position corresponding with the smaller, second sized cable based on a second protrusion on the extension of the second component 200 mating with a cut on a tab face of the first component 100. The second protrusion referenced above may be positioned further up the extension of the second component 200 than the first protrusion such that the second protrusion locks the position of the second component 200 relative to the first component 100 when the extension of the second component 100 is further into the second component cutout of the first component 100 than the first protrusion referenced above.

In some implementations, the extension of the second component 200 may include one protrusion on a face of the extension of the second component 200 and a tab of the first component 100 may include one cut such that when coupled, the first component 100 and the second component 200 define a space configured to match and secure a certain sized cable.

While the protrusions of the second component 200 are displayed facing outwards, the protrusions could be oriented in any direction so long as a matching tab or other component configured to secure the protrusions matches the protrusions of the second component 200.

In some implementations, a fastener portion of the first component 100 may be positioned at a side of the first component 100. In some such implementations, the second component 200 could be coupled to the first component 100 prior to coupling the first component 100 to the building component. In some such implementations, the cable could be fed through the space defined between the first component 100 and the second component 200 and the second component could be pushed into the first component 100 to secure the cable after it is positioned between the two components.

In some implementations, a second cable may be secured between the second component 200 and a stacking component in addition to the cable secured between the first component 100 and the second component 200. The stacking component may be secured to a stacking component cutout of the second component. After a cable is secured between the first component 100 and the second component 200, a cable could be positioned on a fourth side of the second component 200 and the stacking component may be coupled to the second component 200 such that the cable is secured between the second component and the stacking component. The second component 200 and the stacking component may each define at least a portion of a space for the second cable. The second cable may be secured within the space defined by each of the second component 200 and the stacking component.

In an alternative implementation, an alternative first component could be coupled to a building component. After the alternative first component is coupled to the building component, a cable could be positioned at a side of the alternative first component such that the alternative first component is not interposed between the cable and the building component. An alternative second component could be coupled to the alternative first component or could have been coupled to the alternative first component prior to positioning the cable, prior to coupling the alternative first component to the building component, or prior to both. The alternative second component may be pushed toward the building component to secure the cable. The alternative second component may secure the cable against the building component with a compression force, friction force, or both. The alternative first component may prevent the alternative second component from moving away from the building component.

In another alternative implementation, a different alternative first component could be coupled to a building component. After the different alternative first component is coupled to the building component, a cable could be positioned at a side of the different alternative first component such that the different alternative first component is not interposed between the cable and the building component. A different alternative second component could be coupled to the different alternative first component or could have been coupled to the different alternative first component prior to positioning the cable, prior to coupling the different alternative first component to the building component, or prior to both. The different alternative second component may be pushed toward the different alternative first component, securing the cable between the different alternative first component and different alternative second component with a compression force, friction force, or both. The different alternative first component may prevent the different alternative second comment from moving away from the different alternative first component.

Referring to FIG. 3B, a side view of an example of an apparatus 300 configured to define at least a portion of a space for a cable with a first component 100 of the apparatus 300 positioned above a second component 200 is shown.

Referring to FIG. 3C, a side view of an example of an apparatus 300 configured to define at least a portion of a space for a cable with a first component 100 of the apparatus 300 coupled to a second component 200 is shown.

Referring to FIG. 3D, a cross-sectional view of an example of an apparatus 300 configured to define at least a portion of a space for a cable with a first component 100 of the apparatus 300 coupled to a second component 200 is shown.

Referring to FIG. 3E, a cross-sectional view of a portion of an example of an apparatus 300 configured to define at least a portion of a space for a cable with a first component 100 of the apparatus 300 coupled to a second component 200 is shown.

As shown in FIG. 3E, protrusions of an extension of the second component 200 may mate with cuts on a face of a tab of the first component 100 such that the second component 200 may be prevented from moving away from the first component 100.

The various examples of an apparatus configured to define at least a portion of a space for a cable are used as non-limiting examples of the present disclosure.

In an illustrative implementation, an apparatus may include a first component 100 configured to be coupled to each of a building component and a second component 200, the second component 200 configured to define at least a portion of a space for a cable; and apply a force to the cable to secure the cable. The cable may be secured when the second component 200 is coupled to the first component 100.

In some implementations, the first component may include a first side 104 and a second side 106 different from the first side 104, the first side 104 may be configured to be coupled to the building component, the second side 106 may be configured to be coupled to the second component 200. In some such implementations, the space may be interposed between the second side 106 and the second component 200. In some such implementations, the second side 106 may be interposed between the first side 104 and the second component 200.

In some implementations, the second component 200 may include one or more protrusions on a face of an extension 206 configured to couple the second component 200 to the first component 100 and the first component 100 may include one or more cuts on a face of a tab 114 configured to match the one or more protrusions.

Aspects of the present disclosure enable an installer of a cable within a building to secure cables within a building while eliminating risks of piercing or pinching the cable when securing it. Additionally, the present disclosure significantly reduces the skill needed by an individual installing cables within a building. Further, the present disclosure decreases the time required to secure cables within a building.

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

What is claimed is:

1. An apparatus comprising:
a first component configured to be coupled to each of a building component and a second component, the second component configured to:
define at least a portion of a space for a cable; and
apply a force to the cable to secure the cable.

2. The apparatus according to claim 1, wherein the second component is configured to apply the force to the cable to secure the cable when coupled to the first component.

3. The apparatus according to claim 1, wherein the first component is configured to apply a second force to the cable to secure the cable.

4. The apparatus according to claim 1, wherein the first component is configured to define at least a portion of the space for the cable.

5. The apparatus according to claim 1, wherein the space is interposed between the first component and the second component.

6. The apparatus according to claim 1, wherein the first component includes a first side and a second side different from the first side, the first side configured to be coupled to the building component, the second side configured to be coupled to the second component.

7. The apparatus according to claim 6, wherein the space is interposed between the second side and the second component.

8. The apparatus according to claim 7, wherein the second side is interposed between the first side and the second component.

9. The apparatus according to claim 1, wherein the first component and the second component are configured to secure the cable between the first component and the second component.

10. The apparatus according to claim 1, wherein the first component is separate from the second component.

11. The apparatus according to claim 1, further comprising the second component.

12. The apparatus according to claim 1, wherein the second component includes one or more protrusions configured to couple the second component to the first component and the first component includes one or more cuts configured to match the one or more protrusions.

13. The apparatus according to claim 1, wherein the second component is configured to contact the cable when coupled to the first component.

14. The apparatus according to claim 13, wherein the first component is configured to contact the cable.

15. The apparatus according to claim 1, wherein the force is configured to prevent cable movement with respect to the building component.

16. The apparatus according to claim 1, wherein:
the second component is configured to couple to the first component at a first position;
the second component is configured to couple to the first component at a second position; and
the first component is configured to:
allow movement of the second component from the first position to the second position; and
prevent to movement of the second component from the second position to the first position, the space when the second component is at the second position smaller than the space when the second component is at the first position.

17. The apparatus according to claim 1, wherein the second component is configured to be coupled to a third component, the third component configured to:
define at least a portion of a space for a second cable; and
apply a second force to the second cable to secure the second cable when coupled to the second component.

18. A method for securing a cable to a building component comprising:
coupling a first component to a building component;
positioning the cable at a side of the first component; and
coupling a second component to the first component to secure the cable, the second component configured to:
define at least a portion of a space for the cable; and
apply a force to secure the cable.

19. The method according to claim 18, further comprising:
moving the second component from a first position to a second position, the second component coupled to the first component at each of the first position and the second position, the first component configured to:
allow movement of the second component from the first position to the second position; and
prevent movement of the second component from the second position to the first position, the space when the second component is at the second position smaller than the space when the second component is at the first position.

20. The method according to claim 18, further comprising positioning a first side of the first component against the building component, wherein the cable is positioned against a second side of the first component, the first side opposite the second side, the cable interposed between the second side and the second component, and the second side interposed between the first side and the cable.
